(19) United States
(12) Patent Application Publication
(10) Pub. No.: US 2010/0111017 A1
(43) Pub. Date: May 6, 2010

(54) METHOD AND APPARATUS OF GENERATING SIGNALS FOR INITIAL RANGING IN OFDMA SYSTEM

(75) Inventors: Jung-Sun Um, Daejon (KR); Sung-Hyun Hwang, Daejon (KR); Chang-Joo Kim, Daejon (KR); Myung-Sun Song, Daejon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejon (KR)

(21) Appl. No.: 12/596,181

(22) PCT Filed: Apr. 21, 2008
(86) PCT No.: PCT/KR08/02229

§ 371 Date: Oct. 16, 2009

(30) Foreign Application Priority Data
Apr. 19, 2007 (KR) 10-2007-0038374

(51) Int. Cl. H04W 72/04

(52) U.S. Cl. 370/329

(57) ABSTRACT

Provided is a method and apparatus of generating signals for initial ranging in an Orthogonal Frequency Division Multiple Access (OFDMA) system. The method, includes: generating a plurality of ranging symbols by cyclic-shifting sample data of a ranging symbol in one OFDMA symbol period as much as a value obtained by multiplying a cyclic prefix size by a symbol index; generating a ranging signal by copying a rear part corresponding to the cyclic prefix size in the sample data with respect to each of the ranging symbols and inserting the copied rear part in front of the sample data as a cyclic prefix.

### TECHNICAL FIELD

The present invention relates to a method and apparatus of generating signals for initial ranging in an Orthogonal Frequency Division Multiple Access (OFDMA) system; and, more particularly, to a method and apparatus of generating signals for initial ranging in the same procedure with no regard to increase of the number of continuous symbols.

This work was supported by the IT R&D program for MIC/IIIA [2005-S-002-03, “Development of cognitive radio technology for efficient spectrum utilization”].

### BACKGROUND ART

In an Orthogonal Frequency Division Multiple Access (OFDMA) system, signals transmitted from terminals should arrive at a base station at reference timing. The base station estimates timing offset of the signals transmitted from the terminals and controls transmission timing of the terminals located in different places based on the estimation result, thereby synchronizing timing of the reception signal of terminals. Therefore, an initial ranging procedure for controlling transmission timing before data transmission is required for the terminal to make a new access to the base station.

The initial ranging is performed based on a Pseudo Random (PN) code in conventional Institute of Electrical and Electronics Engineers (IEEE) 802.16. Each terminal randomly selects a ranging code and transmits the selected ranging code to a randomly selected ranging sub-channel. The base station detects a ranging signal through a correlated operation of all available ranging codes in each ranging sub-channel and estimates time offset for the received signal. Accordingly, transmission power of the terminal can be controlled in an initial ranging procedure by estimating the reception power of the received signal.

Since the timings that the initial ranging signal arrives at the base station are different according to a distance between the terminal and the base station and it is difficult to predict the timing, a ranging signal generated to be the same ranging code of more than two symbols should be transmitted. The number of symbols forming the ranging signal may increase according to a propagation delay time due to the cell range of the system. When phase between two symbols is discontinuous, Inter-carrier interference (ICI) occurs in a frequency domain, thereby deteriorating detection performance. Accordingly, phase should be designed in a continuous format between neighboring symbols.

In the conventional IEEE 802.16, when a format of a time domain symbol having a sample number N_{FFT} of a Fast Fourier Transform (FFT) size after Inverse FFT (IFFT) of the ranging code is as shown in FIG. 1(a), two symbols generated as the same code as shown in FIG. 1(b) are continuously transmitted. The size of each symbol has a symbol size N_{sym} where a sample sequence of a cyclic prefix (CP) size N_{CP} is copied and inserted. In order to maintain continuity of the phase between two symbols, a first symbol uses a general cyclic prefix inserting method. On the other hand, a secondly transmitted symbol uses a method of forming the symbol after IFFT to be close to the first symbol, copying a front section of the symbol of the cyclic prefix size and inserting the copied front section to a rear part.

In this second symbol generating procedure, a signal processing method and a buffer may be required in addition to a general cyclic prefix inserting method. Also, when the cell region of the system increases and more than three ranging symbols are required as initial ranging, a new method should be defined. FIG. 2 shows an example of a symbol format in case where more than three symbols are required. FIG. 2 shows that a procedure of a new method for moving a sample inside a symbol, and copying and inserting a sample of a cyclic prefix size is required. Therefore, the conventional method has a problem that the more the number of symbols increases, the more the complexity increases.

### DISCLOSURE

### Technical Problem

An embodiment of the present invention is directed to providing a method and apparatus for simply generating a signal for initial ranging based on a characteristic of Inverse Fast Fourier Transform (IFFT) without an additional signal process of a time domain and a symbol buffer in an Orthogonal Frequency Division Multiple Access (OFDMA) communication system.

Another embodiment of the present invention is directed to providing a method and apparatus for simply generating a plurality of symbols which can maintain continuity of a phase based on one equation with no regard to the number of OFDMA symbols required in initial ranging.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for generating a signal for initial ranging of an Orthogonal Frequency Division Multiple Access (OFDMA) system, including: generating a plurality of ranging symbols by cyclic-shifting sample data of a ranging symbol in one OFDMA symbol period as much as a value obtained by multiplying a cyclic prefix size by a symbol index; generating a ranging signal by copying a rear part corresponding to the cyclic prefix size in the sample data with respect to each of the ranging symbols and inserting the copied rear part in front of the sample data as a cyclic prefix.

In accordance with another aspect of the present invention, there is provided a method for generating an initial ranging signal of an OFDMA system, including: performing Binary Phase Shift Keying (BPSK) modulation by generating a ranging code; generating symbols phase-rotating the modulated ranging code according to a symbol index and a subcarrier index as many as L numbers meaning a ranging symbol number, which is a natural number equal to or larger than 2, in consideration of a ranging symbol index; mapping the constellation symbols to a subcarrier according to the subcarrier index, transforming the constellation symbols into symbols of a time domain, and generating sample data of L ranging symbols; copying a rear part corresponding to a cyclic prefix size in the sample data with respect to each of the ranging symbols and inserting the rear part in front of the sample data as a cyclic prefix.

In accordance with another aspect of the present invention, there is provided an apparatus for generating a signal for initial ranging of an OFDMA system, including: a ranging code generator for generating a ranging code; a ranging channel former for modulating the ranging code, generating symbols phase-rotating the modulated ranging code according to a symbol index and a subcarrier index as many as L ranging symbols in consideration of a ranging symbol index, and mapping the constellation symbols to subcarriers according to the subcarrier index; a transformer for transforming the symbol mapped to the subcarrier into symbols of a time domain and generating sample data of the ranging symbols; a cyclic prefix inserter for copying a rear part corresponding to a cyclic prefix size in the sample data with respect to each of the ranging symbols, inserting the rear part in front of the sample data as a cyclic prefix, and generating an initial ranging signal.

In accordance with another aspect of the present invention, there is provided an apparatus for generating an initial ranging signal of an OFDMA system, including: a symbol data generator for cyclic-shifting sample data of a ranging symbol in one OFDMA symbol period as much as a value obtained by multiplying a cyclic prefix size by a symbol index and generating a plurality of ranging symbols; and a cyclic prefix inserter for copying a rear part corresponding to the cyclic prefix size in the sample data with respect to each of the ranging symbols and inserting the rear part in front of the sample data as a cyclic prefix.

### ADVANTAGEOUS EFFECTS

Compared with a conventional method, the present invention having the configuration described above does not require an additional signal processing and a buffer for generating a ranging symbol used in an initial ranging procedure performed in an Orthogonal Frequency Division Multiple Access (OFDMA) system. Also, the present invention can simply generate a plurality of symbols maintaining continuity of phase based on one equation with no regard to the number of symbols used in initial ranging.

### BRIEF DESCRIPTION OF THE DRAWINGS

FIG. 1(a) shows an example of a ranging symbol after Inverse Fast Fourier Transform (IFFT) and FIG. 1(b) shows a configuration and generation method of an initial ranging symbol of Institute of Electrical and Electronics Engineers (IEEE) 802.16 in case of two symbols.

FIG. 2 shows a configuration and generation method of an initial ranging symbol of IEEE 802.16 in case of three symbols.

FIG. 3 is a block diagram showing an apparatus for generating an initial ranging signal in accordance with an embodiment of the present invention.

FIG. 4 is a flowchart describing a method for generating an initial ranging signal in accordance with an embodiment of the present invention.

FIG. 5 is a flowchart illustrating a ranging symbol generating step S402 of FIG. 4.

FIG. 6 is a flowchart describing a method for generating an initial ranging signal in accordance with another embodiment of the present invention.

FIG. 7 shows a configuration and generation method of the initial ranging symbol in case of two symbols in accordance with an embodiment of the present invention.

FIG. 8 shows a configuration and generation method of the initial ranging symbol in case of three symbols in accordance with the embodiment of the present invention.

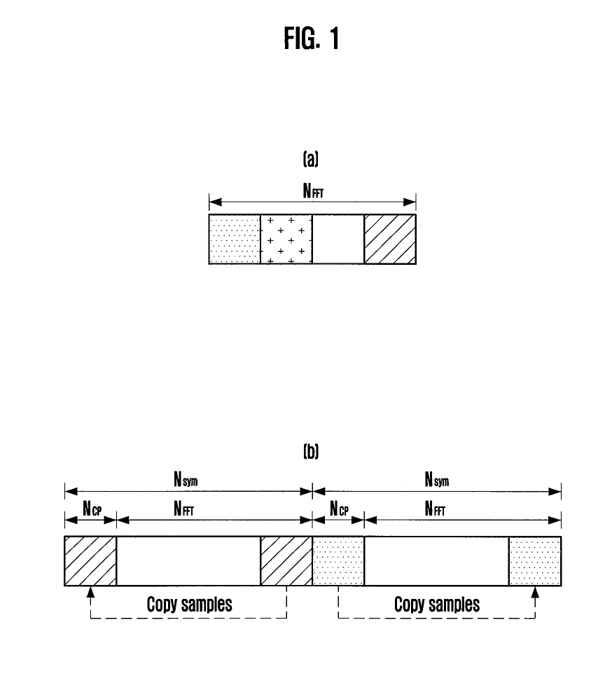

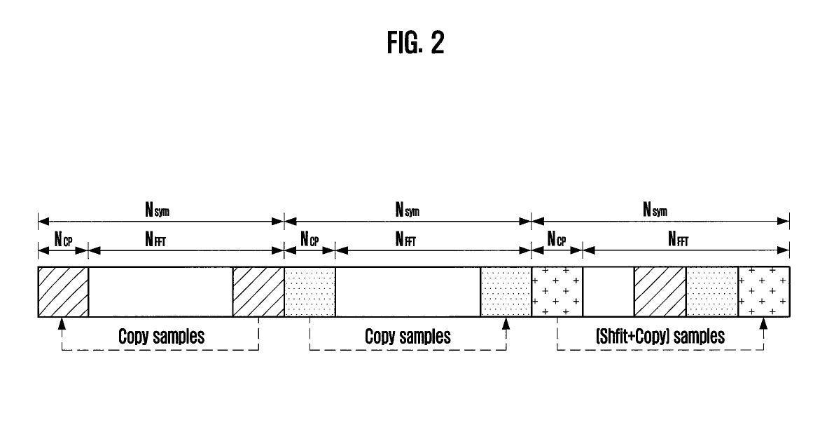

### BEST MODE FOR THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

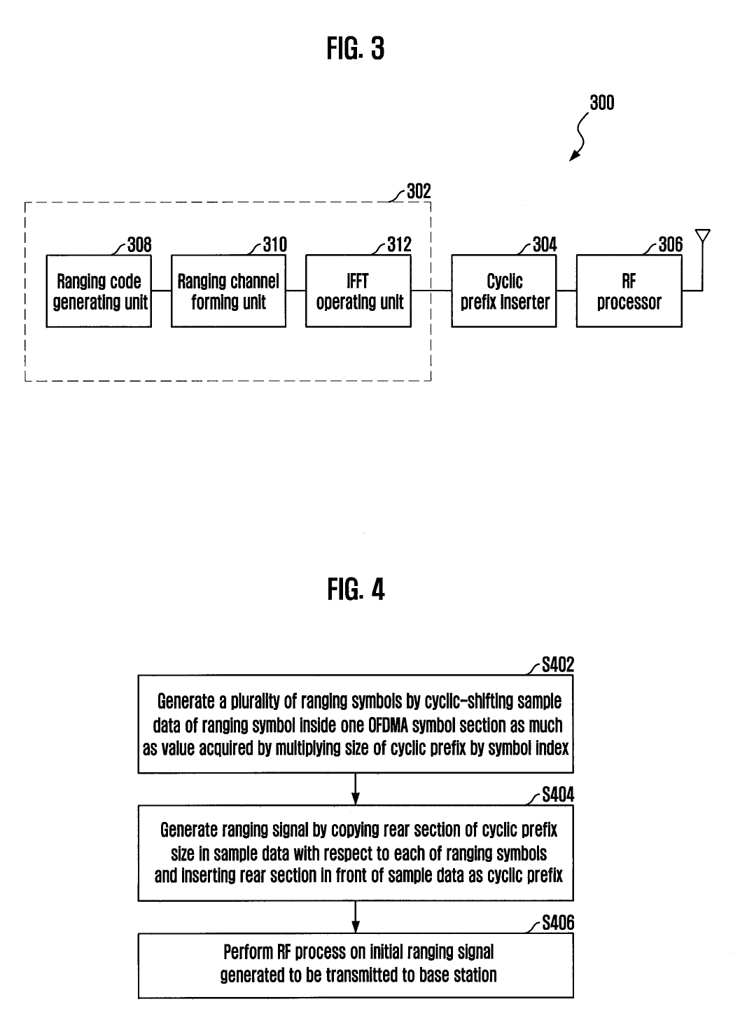

FIG. 3 is a block diagram showing an apparatus for generating an initial ranging signal in accordance with an embodiment of the present invention. As shown in FIG. 3, an initial ranging signal generating apparatus 300 includes a symbol data generator 302, a cyclic prefix inserter 304 and a radio frequency (RF) processor 306.

The symbol data generator 302 generates a plurality of ranging symbols by cyclic-shifting sample data of the ranging symbol in one Orthogonal Frequency Division Multiple Access (OFDMA) symbol period as much as a size of a cyclic prefix is multiplied to a symbol index.

The symbol data generator 302 includes a ranging code generating unit 308, a ranging channel forming unit 310 and an Inverse Fast Fourier Transform (IFFT) operating unit 312. The ranging code generating unit 308 generates a ranging code. The ranging channel forming unit 310 performs Binary Phase Shift Keying (BPSK) on the ranging code generated in the ranging code generating unit 308 to thereby produce a modulated ranging code, then performs phase-rotating the modulated ranging code as much as a value obtained by multiplying a subcarrier index by a value acquired after multiplication of the ranging symbol index and the cyclic prefix size, and thereby generates as many phase-rotated symbols as a ranging symbol number L in consideration of the ranging symbol index. The phase-rotated symbols are mapped to the subcarrier according to the subcarrier index of the ranging sub-channel.

The IFFT operating unit 312 transforms L symbols mapped to the subcarrier into symbols of a time domain and generates sample data of L ranging symbols.

The cyclic prefix inserter 304 copies a rear part corresponding to a cyclic prefix size in the sample data with respect to a plurality of ranging symbols generated in the symbol data generator 302 and inserts the copied rear part in front of the sample data as a cyclic prefix.

The RF processor 306 performs an RF process to transmit an initial ranging signal outputted from the cyclic prefix inserter 304 to a base station.

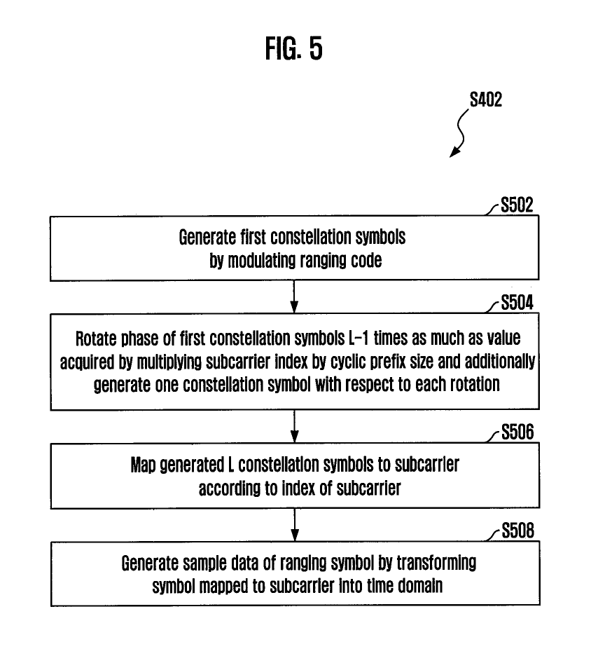

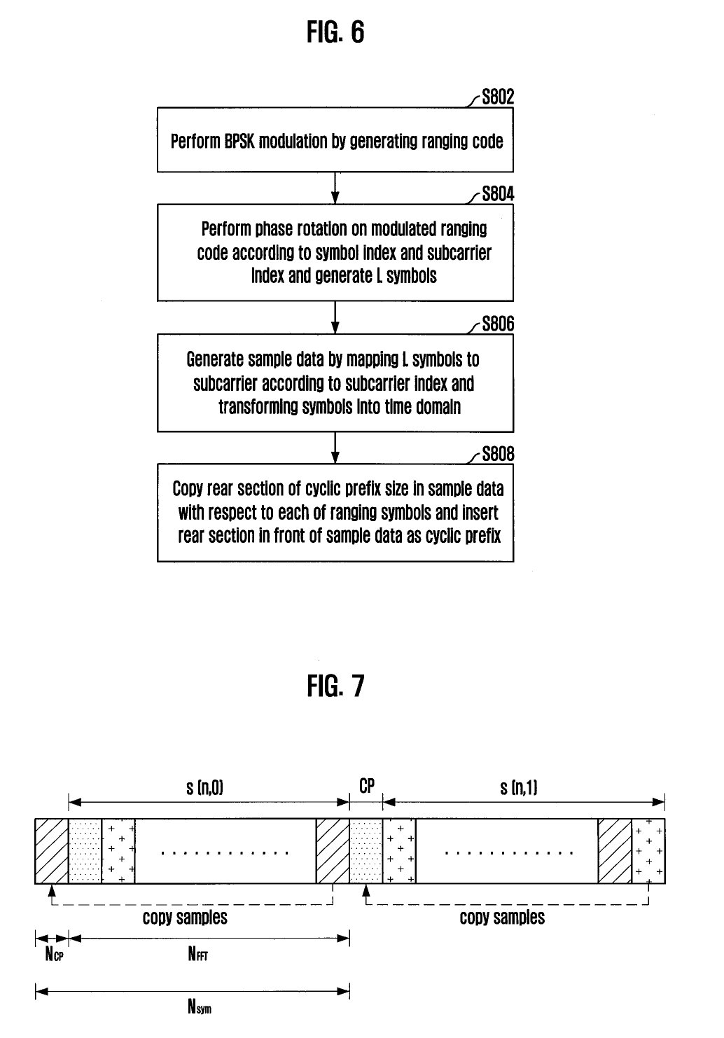

A method for generating an initial ranging signal in accordance with the present invention will be described with reference to FIGS. 5 and 6. FIG. 4 is a flowchart describing a method for generating an initial ranging signal in accordance with an embodiment of the present invention and FIG. 5 is a flowchart illustrating a ranging symbol generating step S402 of FIG. 4.

As shown in FIG. 4, at step S402, a plurality of ranging symbols are generated by cyclic-shifting sample data of the ranging symbol in one OFDMA symbol period as much as the size of the cyclic prefix is multiplied to the symbol index. At step S404, a ranging signal is generated by copying a rear part corresponding to the cyclic prefix size in the sample data with respect to the symbol section and inserting the copied rear part in front of the sample data as a cyclic prefix. At step S406, the RF process is performed on the generated initial ranging signal to be transmitted to the base station.

Referring to FIG. 5, at step S502, a ranging code is modulated and first constellation symbols are generated as shown in the ranging symbol generating step S402. Modulation may be performed according to the BPSK method. At step S504, after rotating the phase of the first constellation symbols as much as the subcarrier index is multiplied to the multiplication of the ranging symbol index and the cyclic prefix size, L ranging symbols are generated in consideration of the ranging symbol index. For example, when 3 ranging symbols are generated, L is 3 and the symbol index is a natural number between 0 and 2. At step S506, the generated L constellation symbols are mapped to the subcarrier according to the index of the subcarrier. At step S508, sample data of the ranging symbol are generated by transforming the symbol mapped to the subcarrier into symbols of a time domain. The step of transforming the symbol mapped to the subcarrier into symbols of the time domain is performed according to Inverse Fast Fourier Transform (IFFT).

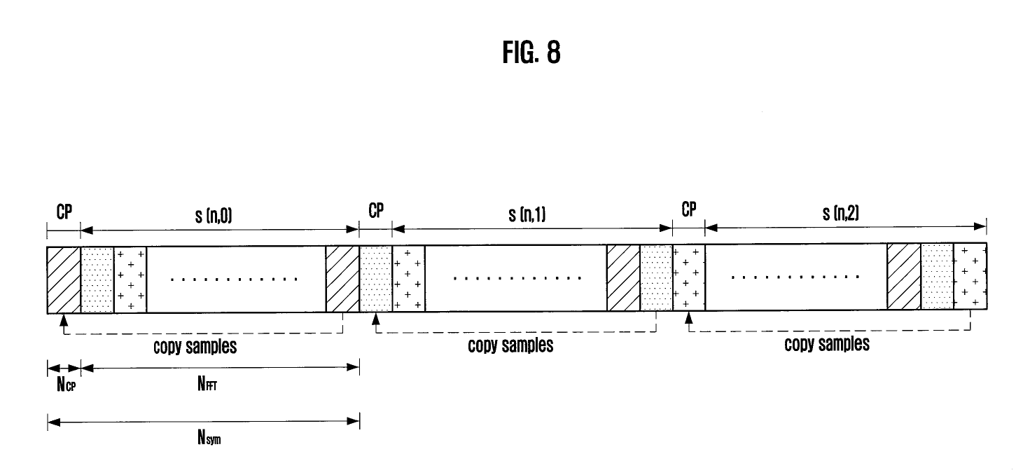

FIG. 8 is a flowchart describing a method for generating an initial ranging signal in accordance with another embodiment of the present invention. The BPSK modulation is performed at step S802 by generating a ranging code. At step S804, after performing phase rotation on the modulated ranging code according to the symbol index and the subcarrier index, L ranging symbols are generated in consideration of the ranging symbol index. At step S806, sample data are generated by mapping the phase rotated symbols to the subcarrier according to the subcarrier index and transforming the symbols into symbols of a time domain. At step S808, a rear part corresponding to a cyclic prefix size is copied in the sample data with respect to each of the ranging symbols and inserted in front of the sample data as a cyclic prefix.

A principle of generating a ranging symbol in the present invention will be described.

When the BPSK modulation is performed on the ranging code in the frequency domain to continuously maintain the phase between ranging symbols in the time domain and the ranging code is mapped to each subcarrier of the ranging sub-channel, specific phase offset is authorized in proportion to the index of each subcarrier. The specific phase offset is the multiplication of a symbol index l=0, 1, 2, . . . , and L−1 of a time domain used in initial ranging and a cyclic prefix size N_{CP}. The present invention is based on a general principle that when specific phase offset is given to the index of each subcarrier in the frequency domain, a symbol pattern in the time domain appears in such a manner that samples in a time domain symbol are cyclic-shifted as many as a sample value corresponding to the specific phase offset.

When the cyclic prefix inserting procedure generally realized in the OFDMA system is performed on the symbol generated after IFFT based on the principle, a plurality of OFDMA symbols having phase continuity as an initial ranging symbol can be generated without additional complexity. This principle is expressed as Equation 1.

$$s ( n , l ) = {\sum }_{k = 0}^{{N}_{FFT} - 1} [ {b}_{k} \cdot {e}^{j 2 π \frac{k \cdot l \cdot {N}_{CP}}{{N}_{FFT}}} ] \cdot {e}^{j 2 π \frac{k \cdot n}{{N}_{FFT}}} , \\ {b}_{k} = \{ \begin{matrix}2 \cdot ( \frac{1}{2} - {C}_{k} ) , & k ∈ R \\ 0 , & k ∉ R\end{matrix} \qquad Eq . 1$$

where s(n,l) represents an OFDMA symbol for l^{th} initial ranging having a sample index n after performing IFFT; k represents a subcarrier index; Cₖ represents a ranging code having a value 0 or 1; R represents an index set of the subcarrier in the ranging sub-channel; N_{FFT} represents an FFT size; and N_{CP} represents a size of a cyclic prefix or a guard interval.

In Equation 1, s(n,l) represents an l^{th} OFDMA symbol of the ranging signal generated as the same ranging code. According to l, each s(n,l) symbol has different cyclic-shifted formats.

When the general cyclic prefix inserting procedure of the OFDMA system is performed on each s(n,l), an initial ranging signal is generated. An example that two and three symbols are generated according to this method is as shown in FIGS. 8 and 9.

FIG. 7 shows a configuration and generation method of the initial ranging symbol in case of two symbols in accordance with an embodiment of the present invention and FIG. 8 shows a configuration and generation method of the initial ranging symbol in case of three symbols in accordance with an embodiment of the present invention. When the l value continuously increases in case of four symbols, an initial ranging symbol can be generated by applying the same equation.

A phase rotating process of the symbol mapped to each subcarrier of the ranging sub-channel in each s(n,l) symbol may be simply performed in the IFFT operation procedure by simplifying Equation 1. Equation 1 is changeable as shown in Equation 2.

$$s ( n , l ) = {\sum }_{k = 0}^{{N}_{FFT} - 1} {b}_{k} \cdot {e}^{j 2 π \frac{k \cdot ( n + l \cdot {N}_{CP} )}{{N}_{FFT}}} \qquad Eq . 2$$

A general IFFT operation is expressed and performed as j2πn/N_{FFT} such as an index part of a second exp of Equation 1. However, the present invention can simply acquire the same phase rotation effect of each subcarrier by performing an IFFT operation in the format of j2πk n+l·N_{CP}/N_{FFT} including offset of l·N_{CP} in an index part of the exp as shown in Equation 2, and generate a ranging symbol of a cyclic-shifted format in the time domain. A method for actually performing IFFT may be differed according to the realizing methods but be based on the same principle.

Compared with the conventional method, the present invention of the above configuration does not require an additional signal process and buffer. Also, although the number of symbols for initial ranging increases, a plurality of OFDMA symbols for initial ranging can be simply generated by changing only the value of the symbol index l of Equation 2.

### BEST MODE FOR THE INVENTION

The method of the present invention as described above may be implemented by a software program that is stored in a computer-readable storage medium such as CD-ROM, RAM, ROM, floppy disk, hard disk, optical magnetic disk, or the like. This process may be readily carried out by those skilled in the art, and therefore, details of thereof are omitted here.

While the present invention has been described with respect to certain preferred embodiments, it will be apparent to those skilled in the art that various changes and modifications may be made without departing from the scope of the invention as defined in the following claims.

What is claimed is:

1. A method for generating a signal for initial ranging of an Orthogonal Frequency Division Multiple Access (OFDMA) system, comprising:
generating a plurality of ranging symbols by cyclic-shifting sample data of a ranging symbol in one OFDMA symbol period as much as a value obtained by multiplying a cyclic prefix size by a symbol index;
generating a ranging signal by copying a rear part corresponding to the cyclic prefix size in the sample data with respect to each of the ranging symbols and inserting the copied rear part in front of the sample data as a cyclic prefix.

2. The method of claim 1, wherein the symbol index is a natural number between 0 and 2.

3. The method of claim 1, wherein said generating a plurality of ranging symbols includes:
generating first constellation symbols by modulating a ranging code;
rotating phase of the first constellation symbols as much as a value obtained by multiplying a subcarrier index by a value acquired after multiplication of the ranging symbol index and the cyclic prefix size and generating L ranging symbols in consideration of the ranging symbol index;
mapping the generated L constellation symbols to subcarriers according to the index of the subcarrier; and
transforming the symbols mapped to the subcarrier into symbols of a time domain and generating sample data of the ranging symbol.

4. The method of claim 3, wherein the ranging symbol transformed into symbols of the time domain is represented as:
$$s ( n , l ) = {\sum }_{k = 0}^{{N}_{FFT} - 1} [ {b}_{k} \cdot {e}^{j 2 π \frac{k \cdot l \cdot {N}_{CP}}{{N}_{FFT}}} ] \cdot {e}^{j 2 π \frac{k \cdot n}{{N}_{FFT}}} , \\ {b}_{k} = \{ \begin{matrix}2 \cdot ( \frac{1}{2} - {C}_{k} ) , & k ∈ R \\ 0 , & k ∉ R\end{matrix}$$
where s(n,l) represents an OFDMA symbol for l^{th} initial ranging having a sample index n;
k represents a subcarrier index;
Cₖ represents a ranging code;
R represents an index set of the subcarrier in a ranging sub-channel;
N_{FFT} represents a Fast Fourier Transform (FFT) size; and
N_{CP} represents a cyclic prefix size.

5. The method of claim 3, wherein L is 3.

6. The method of claim 3, wherein Binary Phase Shift Keying (BPSK) modulation is performed.

7. The method of claim 3, wherein said transforming the symbol mapped to the subcarrier into symbol of the time domain is performed according to an Inverse FFT (IFFT) method.

8. The method of claim 1, further comprising:
performing a Radio Frequency (RF) process on the generated initial ranging signal to be transmitted to a base station.

9. A method for generating an initial ranging signal of an Orthogonal Frequency Division Multiple Access (OFDMA) system, comprising:
performing Binary Phase Shift Keying (BPSK) modulation by generating a ranging code;
generating symbols phase-rotating the modulated ranging code according to a symbol index and a subcarrier index as many as the number L of ranging symbols, which is a natural number equal to or larger than 2, in consideration of a ranging symbol index;
mapping the constellation symbols to a subcarrier according to the subcarrier index, transforming the constellation symbols into symbols of a time domain, and generating sample data of L ranging symbols;
copying a rear part corresponding to a cyclic prefix size in the sample data with respect to each of the ranging symbols and inserting the rear part in front of the sample data as a cyclic prefix.

10. The method of claim 9, wherein the ranging symbol transformed into symbols of the time domain is represented as:
$$s ( n , l ) = {\sum }_{k = 0}^{{N}_{FFT} - 1} [ {b}_{k} \cdot {e}^{j 2 π \frac{k \cdot l \cdot {N}_{CP}}{{N}_{FFT}}} ] \cdot {e}^{j 2 π \frac{k \cdot n}{{N}_{FFT}}} , \\ {b}_{k} = \{ \begin{matrix}2 \cdot ( \frac{1}{2} - {C}_{k} ) , & k ∈ R \\ 0 , & k ∉ R\end{matrix}$$
where s(n,l) represents an OFDMA symbol for l^{th} initial ranging having a sample index n;
k represents a subcarrier index;
Cₖ represents a ranging code;
R represents an index set of the subcarrier in a ranging sub-channel;
N_{FFT} represents a Fast Fourier Transform (FFT) size; and
N_{CP} represents a cyclic prefix size.

11. The method of claim 9, wherein L is 3.

12. The method of claim 9, wherein said transforming the constellation symbols into symbols of a time domain is performed according to Inverse Fast Fourier Transform (IFFT) method.

13. The method of claim 9, further comprising:
performing a Radio Frequency (RF) process on an initial ranging signal generated to be transmitted to a base station.

14. An apparatus for generating a signal for initial ranging of an Orthogonal Frequency Division Multiple Access (OFDMA) system, comprising:
a ranging code generator for generating a ranging code;
a ranging channel former for modulating the ranging code, generating symbols phase-rotating the modulated ranging code according to a symbol index and a subcarrier index as many as L ranging symbols in consideration of a ranging symbol index, and mapping the constellation symbols to subcarriers according to the subcarrier index;
a transformer for transforming the symbol mapped to the subcarrier into symbols of a time domain and generating sample data of the ranging symbols;
a cyclic prefix inserter for copying a rear part corresponding to a cyclic prefix size in the sample data with respect to each of the ranging symbols, inserting the rear part in front of the sample data as a cyclic prefix, and generating an initial ranging signal.

15. The apparatus of claim 14, wherein the ranging symbol transformed into symbols of the time domain is represented as:
$$s ( n , l ) = {\sum }_{k = 0}^{{N}_{FFT} - 1} [ {b}_{k} \cdot {e}^{j 2 π \frac{k \cdot l \cdot {N}_{CP}}{{N}_{FFT}}} ] \cdot {e}^{j 2 π \frac{k \cdot n}{{N}_{FFT}}} , \\ {b}_{k} = \{ \begin{matrix}2 \cdot ( \frac{1}{2} - {C}_{k} ) , & k ∈ R \\ 0 , & k ∉ R\end{matrix}$$
where s(n,l) represents an OFDMA symbol for l^{th} initial ranging having a sample index n;
k represents a subcarrier index;
Cₖ represents a ranging code;
R represents an index set of the subcarrier in a ranging sub-channel;
N_{FFT} represents a Fast Fourier Transform (FFT) size; and
N_{CP} represents a cyclic prefix size.

16. The apparatus of claim 14, wherein L is 3.

17. The apparatus of claim 14, wherein Binary Phase Shift Keying (BPSK) modulation is performed on the ranging code.

18. The apparatus of claim 14, wherein the transformer performs Inverse FFT (IFFT).

19. The apparatus of claim 14, further comprising:
a radio frequency (RF) processor for performing an RF process on the initial ranging signal generated to be transmitted to a base station.

20. An apparatus for generating an initial ranging signal of an Orthogonal Frequency Division Multiple Access (OFDMA) system, comprising:
a symbol data generator for cyclic-shifting sample data of a ranging symbol in one OFDMA symbol period as much as a value obtained by multiplying a cyclic prefix size by a symbol index and generating a plurality of ranging symbols; and
a cyclic prefix inserter for copying a rear part corresponding to the cyclic prefix size in the sample data with respect to each of the ranging symbols and inserting the rear part in front of the sample data as a cyclic prefix.
